(19) United States
(12) Patent Application Publication
(10) Pub. No.: US 2023/0292794 A1
(43) Pub. Date: Sep. 21, 2023

(54) BEER-TASTE BEVERAGE

(71) Applicant: SUNTORY HOLDINGS LIMITED, Osaka-shi, Osaka (JP)

(72) Inventors: Yuichi Kato, Tokyo (JP); Yugo Hayakawa, Osaka (JP); Tomoyuki Kishimoto, Osaka (JP); Hiroyuki Abe, Tokyo (JP)

(73) Assignee: SUNTORY HOLDINGS LIMITED, Osaka-shi, Osaka (JP)

(21) Appl. No.: 18/010,688

(22) PCT Filed: Jun. 17, 2021
(86) PCT No.: PCT/JP2021/023061

§ 371 Date: Dec. 15, 2022

(30) Foreign Application Priority Data
Jun. 19, 2020 (JP) 2020-106084

(51) Int. Cl. A23L 2/38; A23L 7/20; A23L 29/30; A23L 2/56

(52) U.S. Cl. CPC A23L 2/38; A23L 7/20; A23L 29/30; A23L 2/56; A23V 2002/00; A23V 2250/21

(57) ABSTRACT

Provided is a beer-taste beverage, comprising less than 0.07 ppm by mass of diacetyl, and 0.4 (v/v) % or more and less than 1.5 (v/v) % of ethanol, having an H₂S content of less than 5 ppb by mass, and comprising 50 to 1000 ppm by mass of lactic acid, or 50 to 1000 ppm by mass of phosphoric acid.

### TECHNICAL FIELD

The present invention relates to a beer-taste beverage.

### BACKGROUND ART

In recent years, to cater to health-conscious consumers, a demand for low alcohol beer with reduced alcohol concentration has increased. However, such low alcohol beer generally tends to have a lighter taste than ordinary beer, and thus, the low alcohol beer tends to have a monotonous taste with no thickness.

In general, in order to impart thickness to beverages by addition of a flavor, a method of improving a flavor by mixing an additive into a beverage has been known. For example, Patent Literature 1 (Patent Publication (Kokai) No. 2019-208453 A) discloses a non-alcoholic beer, into which hydroxy acid esters are mixed, and in which the ratio of sweetness to the concentration (mass) of the hydroxy acid esters is adjusted into a specific range, so that good feeling can be left while going down the throat, without increasing extract portions.

In a fermentation step in general beer manufacturing, sugars, amino acids and the like are metabolized by yeasts, and ethanol, esters, higher alcohols and the like are produced by such yeasts, so that these ingredients impart a beer-like flavor. However, in general, a non-alcoholic beer-taste beverage, in which the content of ethanol is 0.00%, is produced without performing a fermentation step, and thus, flavors such as esters and higher alcohols are added, so that a feeling of fermentation is imparted to the beverage at times. It is difficult, however, to reproduce beer-like fermentation feeling only by addition of such flavors.

### CITATION LIST

### Patent Literature

Patent Literature 1: Patent Publication (Kokai) No. 2019-208453 A

### SUMMARY OF INVENTION

### Technical Problem

The present invention provides: a beer-taste beverage, in which the content of ethanol is low, and which is excellent in terms of a feeling of fermentation suitable for beer-taste beverages and a flavor; and a method for producing the same.

### Solution to Problem

The present invention includes the inventions of the following embodiments.

[1]

A beer-taste beverage, comprising less than 0.07 ppm by mass of diacetyl, and 0.4 (v/v)% or more and less than 1.5 (v/v)% of ethanol,
having an H₂S content of less than 5 ppb by mass, and
comprising 50 to 1000 ppm by mass of lactic acid, or 50 to 1000 ppm by mass of phosphoric acid.

[2]

The beer-taste beverage according to the above [1], comprising 0.01 ppm by mass or more of ethyl acetate.

[3]

The beer-taste beverage according to the above [1] or [2], having a pH value of less than 4.0.

[4]

The beer-taste beverage according to any one of the above [1] to [3], comprising 0.3% to 6.0% by mass of maltose.

[5]

The beer-taste beverage according to any one of the above [1] to [4], having a real extract concentration of 1 to 10 (w/w)%.

[6]

The beer-taste beverage according to any one of the above [1] to [4], wherein the beer-taste beverage is a fermented beer-taste beverage.

[7]

A method for producing a beer-taste beverage, comprising:
a step of producing a wort from a raw material comprising a malt and water, and
a step of adding a yeast to the wort to perform fermentation, wherein
the additive amount of the yeast in the fermentation step is 40×10⁶ cells/mL or more, and the fermentation temperature is 1° C. to 21° C.

[8]

The production method according to the above [7], wherein the fermentation time in the fermentation step is 1 hour or more.

[9]

The production method according to the above [7] or [8], further comprising a step of adding hops.

[10]

The production method according to any one of the above [7] to [9], further comprising a step of adding a brewed vinegar.

[11]

The production method according to any one of the above [7] to [10], wherein the yeast is a bottom fermentation yeast.

[12]

A beer-taste beverage produced by the production method according to any one of the above [7] to [11].

[12-1]

The beer-taste beverage according to any one of the above [1] to [6], which is produced by the production method according to any one of the above [7] to [11].

### Advantageous Effects of Invention

The beer-taste beverage according to one preferred embodiment of the present invention can be a beverage, which has a low ethanol content and is excellent in terms of a feeling of fermentation suitable for beer-taste beverages and a flavor.

### DESCRIPTION OF EMBODIMENTS

1. Beer-Taste Beverage

The beer-taste beverage according to one embodiment of the present invention is a beverage having a lower content of ethanol than those of common beer-taste beverages, and specifically, the beer-taste beverage according to one embodiment of the present invention contains 0.4 (v/v)% or more and less than 1.5 (v/v)% of ethanol. Thereby, there can be provided a beverage having an excellent feeling of fermentation and an excellent flavor, compared with non-alcoholic beer-taste beverages containing no ethanol.

In the present description, the “beer-taste beverage” is not particularly limited, as long as it is a beverage having a beer flavor. With regard to the type of such a beer-taste beverage, examples of the beer-taste beverage may include an alcohol-containing beer-taste beverage, and a non-alcoholic beer-taste beverage having an alcohol content of less than 1 (v/v)%. That is to say, the beer-taste beverage of the present description includes all carbonated beverages having a beer flavor, unless otherwise specified. Therefore, the present beer-taste beverage is not limited to beverages produced by adding a yeast to a wort and then performing a fermentation, but it also includes carbonated beverages, to which beer flavors including esters, higher alcohols (for example, isoamyl acetate, ethyl acetate, n-propanol, isobutanol, acetaldehyde, and ethyl caproate), 4-vinylguaiacol, linalool, and the like are added.

The beer-taste beverage of the present invention may be either a beer-taste beverage comprising a malt, in which a malt is used as a raw material, or a beer-taste beverage not comprising a malt, in which a malt is not used as a raw material. A beer-taste beverage comprising a malt is preferable, and a beer-taste beverage comprising a barley malt is more preferable.

The beer-taste beverage of the present invention may be a fermented beer-taste beverage produced by performing a fermentation step using a top fermentation yeast (Saccharomyces cerevisiae, etc.) or a bottom fermentation yeast, or may also be a non-fermented beer-taste beverage produced without performing such a fermentation step. A fermented beer-taste beverage is preferable, a fermented malt beer-taste beverage is more preferable, and a fermented barley malt beer-taste beverage is further preferable.

Moreover, the beer-taste beverage of the present invention may also be a distilled liquor-containing beer-taste beverage that contains a distilled liquor such as spirits, whiskey or shochu, and among others, a spirit-containing beer-taste beverage is preferable.

The content of ethanol in the beer-taste beverage according to one embodiment of the present invention is less than 1.5 (v/v)%. From the viewpoint of achieving a beer-taste beverage having more improved feeling of fermentation, the content of ethanol in the beer-taste beverage is preferably less than 1.3 (v/v)%, more preferably less than 1.1 (v/v)%, and further preferably less than 1.0 (v/v)%. The content of ethanol in the beer-taste beverage may also be less than 0.9 (v/v)%, less than 0.8 (v/v)%, less than 0.7 (v/v)%, or less than 0.6 (v/v)%.

On the other hand, the content of ethanol in the beer-taste beverage according to one embodiment of the present invention is 0.4 (v/v)%, preferably 0.41 (v/v)% or more, more preferably 0.42 (v/v)% or more, even more preferably 0.43 (v/v)% or more, further preferably 0.44 (v/v)% or more, still further preferably 0.45 (v/v)% or more, still further preferably 0.48 (v/v)% or more, and particularly preferably 0.50 (v/v)%.

In the present description, the content of ethanol is indicated with the percentage (v/v)% of volume/volume basis. In addition, the content of ethanol in the beverage can be measured by all of known methods, and it can be measured, for example, using an oscillatory density meter.

The content of ethanol can be adjusted by determining, as appropriate, addition of a diluting solution or carbonated water, the types of raw materials (malts, corn grits, a sugar solution, etc.), the amounts of the raw materials, the type of an enzyme, the additive amount of the enzyme, the timing of adding the enzyme, the saccharification time in a preparation tank, the proteolysis time in the preparation tank, the pH in the preparation tank, the pH in a preparation step (a wort-producing step after addition of the malts and before addition of the yeast), the additive amount of an acid used upon the pH adjustment, the timing of the pH adjustment (at the time of preparation, during fermentation, at completion of the fermentation, before beer filtration, after beer filtration, etc.), the preset temperature in each temperature range and retention time during preparation of a wort (including during saccharification), the concentration of an original extract in a pre-fermentation solution, the concentration of an original extract in a fermentation step, fermentation conditions (oxygen concentration, aeration conditions, the variety of the yeast, the additive amount of the yeast, the number of proliferating yeast cells, the timing of removing the yeast, fermentation temperature, fermentation time, pressure setting, carbon dioxide concentration, etc.), addition of spirits, distilled alcohols and the like, etc.

The beer-taste beverage of the present invention comprises less than 0.07 ppm by mass of diacetyl. The content of diacetyl in the beer-taste beverage of the present invention is preferably 0.068 ppm by mass or less, more preferably 0.065 ppm by mass or less, and further preferably 0.063 ppm by mass or less. Moreover, the content of diacetyl in the beer-taste beverage of the present invention may be 0.060 ppm by mass or less, 0.058 ppm by mass or less, 0.056 ppm by mass or less, 0.053 ppm by mass or less, or 0.050 ppm by mass or less.

On the other hand, the lower limit of the content of diacetyl in the beer-taste beverage of the present invention is not particularly limited, and it may be 0.001 ppm by mass or more, 0.01 ppm by mass or more, 0.02 ppm by mass or more, 0.03 ppm by mass or more, 0.04 ppm by mass or more, or 0.05 ppm by mass or more.

Besides, the content of diacetyl may be adjusted by adding diacetyl to the beer-taste beverage, or may also be adjusted after fermentation conditions and the like are determined, as appropriate.

The content of diacetyl can be measured by gas chromatography.

The content of diacetyl can be adjusted by determining, as appropriate, addition of a diluting solution or carbonated water, addition of a diacetyl-containing flavor, the amount of the diacetyl-containing flavor, the amounts of diacetyl-containing raw materials, addition of the diacetyl-containing raw materials, the types of raw materials, the amounts of the raw materials, the type of an enzyme, the additive amount of the enzyme, the timing of adding the enzyme, the preset temperature in each temperature range, retention time, and pH during preparation of a wort (including during saccharification), the concentration of an original extract in a pre-fermentation solution, the pH of the pre-fermentation solution, the concentration of an original extract in a fermentation step, the pH in the fermentation step, fermentation conditions (pH, oxygen concentration, aeration conditions, the variety of the yeast, the additive amount of the yeast, the number of proliferating yeast cells, the timing of removing the yeast, fermentation temperature, fermentation time, pressure setting, carbon dioxide concentration, post fermentation conditions, maturation conditions, cooling timing, temperature change timing, etc.), and the like.

The content of H₂S in the beer-taste beverage of the present invention is less than 5 ppb by mass. If the amount of H₂S contained in the beverage, the beverage has a sulfur smell. Accordingly, the content of H₂S in the present beer-taste beverage is preferably 4.5 ppb by mass or less, more preferably 3.5 ppb by mass, even more preferably 3.0 ppb by mass or less, further preferably 2.5 ppb by mass or less, still further preferably 2.4 ppb by mass or less, still further preferably 2.3 ppb by mass or less, still further preferably 2.2 ppb by mass or less, still further preferably 2.1 ppb by mass or less, still further preferably 2.0 ppb by mass or less, still further preferably 1.9 ppb by mass or less, still further preferably 1.8 ppb by mass or less, still further preferably 1.7 ppb by mass or less, still further preferably 1.6 ppb by mass or less, still further preferably 1.5 ppb by mass or less, still further preferably 1.4 ppb by mass or less, still further preferably 1.3 ppb by mass or less, still further preferably 1.2 ppb by mass or less, still further preferably 1.1 ppb by mass or less, and still further preferably 1.0 ppb by mass or less. Moreover, it is particularly preferable that the beverage of the present invention does not comprise H₂S.

In the present description, the content of H₂S can be measured by gas chromatography.

The content of H₂S can be adjusted by determining, as appropriate, addition of a diluting solution or carbonated water, the types of raw materials, the amounts of the raw materials, the type of an enzyme, the additive amount of the enzyme, the timing of adding the enzyme, the preset temperature in each temperature range, retention time, and pH during preparation of a wort (including during saccharification), the concentration of an original extract in a pre-fermentation solution, the pH of the pre-fermentation solution, the concentration of an original extract in a fermentation step, the pH in the fermentation step, fermentation conditions (pH, oxygen concentration, aeration conditions, the variety of the yeast, the additive amount of the yeast, the number of proliferating yeast cells, the timing of removing the yeast, fermentation temperature, fermentation time, pressure setting, carbon dioxide concentration, post fermentation conditions, maturation conditions, cooling timing, temperature change timing, etc.), beer filtration conditions, and the like. H₂S is generated by a yeast. After generation of H₂S, if the H₂S is intended to be reduced from a beverage or a fermented solution (including solutions during fermentation and at the time of completion of the fermentation), the amount of H₂S can be reduced by a method of supplying gas such as carbon dioxide or nitrogen to the tank, namely, a method called bubbling. Otherwise, the amount of H₂S can also be reduced by increasing the temperature.

Since the content of ethanol in the beer-taste beverage of the present invention is less than 1.5 (v/v)%, microbiological assurance is required by decreasing a pH value. Specifically, while the pH value is kept at a certain value or less, organic acid that is a sour taste-imparting substance needs to be added to the beverage, to such an extent that an unsuitable sourness-imparting substance is not added to the beverage.

By allowing the beer-taste beverage of the present invention to comprise 50 to 1000 ppm by mass of lactic acid or 50 to 1000 ppm by mass of phosphoric acid, it becomes possible not to add an unsuitable sourness-imparting substance to the beverage, while microbiological assurance is ensured by decreasing the pH value.

In order not to impart an unsuitable sourness to the beer-taste beverage of the present invention, the content of lactic acid in the beverage of the present invention is preferably 900 ppm by mass or less, more preferably 700 ppm by mass or less, even more preferably 500 ppm by mass or less, further preferably 300 ppm by mass or less, and particularly preferably 200 ppm by mass or less.

In addition, in order to decrease the pH of the beer-taste beverage of the present invention to obtain microbiological assurance, the content of lactic acid in the beverage of the present invention is preferably 70 ppm by mass or more, more preferably 100 ppm by mass or more, even more preferably 110 ppm by mass or more, further preferably 130 ppm by mass or more, and particularly preferably 150 ppm by mass or more.

Likewise, in order not to impart an unsuitable sourness to the beer-taste beverage of the present invention, the content of phosphoric acid in the beverage of the present invention is preferably 900 ppm by mass or less, more preferably 700 ppm by mass or less, even more preferably 500 ppm by mass or less, further preferably 300 ppm by mass or less, and particularly preferably 200 ppm by mass or less.

In addition, in order to decrease the pH of the beer-taste beverage of the present invention to obtain microbiological assurance, the content of phosphoric acid in the beverage of the present invention is preferably 70 ppm by mass or more, more preferably 100 ppm by mass or more, even more preferably 120 ppm by mass or more, further preferably 140 ppm by mass or more, and particularly preferably 160 ppm by mass or more.

The beer-taste beverage of the present invention preferably comprises lactic acid and phosphoric acid.

From the viewpoint of imparting a moderate sourness to the beer-taste beverage, the total content of lactic acid and phosphoric acid is preferably 1700 ppm by mass or less, more preferably 1300 ppm by mass or less, even more preferably 1000 ppm by mass or less, further preferably 700 ppm by mass or less, and particularly preferably 500 ppm by mass or less. On the other hand, from the viewpoint of decreasing the pH of the beverage to obtain microbiological assurance, the total content of lactic acid and phosphoric acid is preferably 100 ppm by mass or more, more preferably 150 ppm by mass or more, further preferably 200 ppm by mass or more, and particularly preferably 300 ppm by mass or more.

The content of lactic acid and phosphoric acid in the beer-taste beverage of the present invention can be controlled, for example by adjusting the used amounts of lactic acid, phosphoric acid, and raw materials having a high content of lactic acid or phosphoric acid.

Besides, the beer-taste beverage of the present invention may comprise organic acids other than lactic acid and phosphoric acid.

The content of such organic acids other than lactic acid and phosphoric acid can be set to be less than 100 parts by mass, less than 70 parts by mass, less than 50 parts by mass, less than 20 parts by mass, less than 10 parts by mass, less than 5 parts by mass, less than 1 part by mass, less than 0.1 part by mass, or 0 part by mass, with respect to 100 parts by mass of the total content of lactic acid and phosphoric acid.

The content of lactic acid and phosphoric acid in the beer-taste beverage of the present invention can be measured, for example, by high performance liquid chromatography.

From the viewpoint of further improving a feeling of fermentation suitable for beer-taste beverages, the beer-taste beverage according to one embodiment of the present invention is preferably a fermented beer-taste beverage.

After a fermentation step is performed using a yeast, flavor components capable of further improving a feeling of fermentation, such as ethyl acetate and isoamyl acetate, are generated.

Accordingly, the beer-taste beverage according to one embodiment of the present invention preferably comprises ethyl acetate in an amount of 0.01 ppm by mass or more.

The content of ethyl acetate is preferably 0.01 ppm by mass or more, more preferably 0.1 ppm by mass or more, even more preferably 0.3 ppm by mass or more, further preferably 0.5 ppm by mass or more, still further preferably 0.6 ppm by mass or more, still further preferably 0.7 ppm by mass or more, still further preferably 0.8 ppm by mass or more, still further preferably 0.9 ppm by mass or more, and particularly preferably 1.0 ppm by mass or more. On the other hand, the content of ethyl acetate is preferably 55 ppm by mass or less, more preferably 50 ppm by mass or less, even more preferably 45 ppm by mass or less, further preferably 40 ppm by mass or less, still further preferably 37.5 ppm by mass or less, still further preferably 35 ppm by mass or less, still further preferably 32.5 ppm by mass or less, and particularly preferably 30 ppm by mass or less. The content of ethyl acetate may also be 25 ppm by mass or less, 20 ppm by mass or less, 15 ppm by mass or less, 10 ppm by mass or less, 5 ppm by mass or less, 3 ppm by mass or less, 2 ppm by mass or less, or 1.5 ppm by mass or less.

The content of ethyl acetate can be measured by gas chromatography.

The content of ethyl acetate can be adjusted by determining, as appropriate, addition of a diluting solution or carbonated water, addition of an ethyl acetate-containing flavor, the amount of the ethyl acetate-containing flavor, the amounts of ethyl acetate-containing raw materials, addition of the ethyl acetate-containing raw materials, the types of the ethyl acetate-containing raw materials, the amount of a substrate for ethyl acetate, the amount of a raw material serving as a substrate for ethyl acetate, the type of an enzyme, the additive amount of the enzyme, the timing of adding the enzyme, the saccharification time in a preparation tank, the proteolysis time in the preparation tank, the pH in the preparation tank, the pH in a preparation step (a wort-producing step after addition of the malts and before addition of the yeast), the additive amount of an acid used upon the pH adjustment, the timing of the pH adjustment (at the time of preparation, during fermentation, at completion of the fermentation, before beer filtration, after beer filtration, etc.), the preset temperature in each temperature range and retention time during preparation of a wort (including during saccharification), the concentration of an original extract in a pre-fermentation solution, the concentration of an original extract in a fermentation step, fermentation conditions (oxygen concentration, aeration conditions, the variety of the yeast, the additive amount of the yeast, the number of proliferating yeast cells, the timing of removing the yeast, fermentation temperature, fermentation time, pressure setting, carbon dioxide concentration, etc.), and the like.

Furthermore, the beer-taste beverage according to one embodiment of the present invention preferably comprises isoamyl acetate in an amount of 0.001 ppm by mass or more.

The content of isoamyl acetate in the beer-taste beverage according to one embodiment of the present invention is preferably 0.001 ppm by mass or more, more preferably 0.01 ppm by mass or more, even more preferably 0.02 ppm by mass or more, further preferably 0.03 ppm by mass or more, still further preferably 0.04 ppm by mass or more, still further preferably 0.05 ppm by mass or more, still further preferably 0.06 ppm by mass or more, still further preferably 0.07 ppm by mass or more, still further preferably 0.08 ppm by mass or more, still further preferably 0.09 ppm by mass or more, and particularly preferably 0.10 ppm by mass or more.

On the other hand, the content of isoamyl acetate is preferably 25 ppm by mass or less, more preferably 20 ppm by mass or less, even more preferably 15 ppm by mass or less, further preferably 12.5 ppm by mass or less, still further preferably 10 ppm by mass or less, still further preferably 9 ppm by mass or less, still further preferably 8 ppm by mass or less, still further preferably 7 ppm by mass or less, still further preferably 6 ppm by mass or less, and particularly preferably 5 ppm by mass or less. The content of isoamyl acetate may also be 4 ppm by mass or less, 3 ppm by mass or less, 2 ppm by mass or less, 1 ppm by mass or less, 0.70 ppm by mass or less, 0.50 ppm by mass or less, 0.30 ppm by mass or less, or 0.20 ppm by mass or less.

The content of isoamyl acetate can be measured by gas chromatography.

The content of isoamyl acetate can be adjusted by determining, as appropriate, addition of a diluting solution or carbonated water, addition of an isoamyl acetate-containing flavor, the amount of the isoamyl acetate-containing flavor, the amounts of isoamyl acetate-containing raw materials, addition of the isoamyl acetate-containing raw materials, the types of the isoamyl acetate-containing raw materials, the amount of a substrate for isoamyl acetate, the amount of a raw material serving as a substrate for isoamyl acetate, the type of an enzyme, the additive amount of the enzyme, the timing of adding the enzyme, the saccharification time in a preparation tank, the proteolysis time in the preparation tank, the pH in the preparation tank, the pH in a preparation step (a wort-producing step after addition of the malts and before addition of the yeast), the additive amount of an acid used upon the pH adjustment, the timing of the pH adjustment (at the time of preparation, during fermentation, at completion of the fermentation, before beer filtration, after beer filtration, etc.), the preset temperature in each temperature range and retention time during preparation of a wort (including during saccharification), the concentration of an original extract in a pre-fermentation solution, the concentration of an original extract in a fermentation step, fermentation conditions (oxygen concentration, aeration conditions, the variety of the yeast, the additive amount of the yeast, the number of proliferating yeast cells, the timing of removing the yeast, fermentation temperature, fermentation time, pressure setting, carbon dioxide concentration, etc.), and the like.

In the beer-taste beverage according to one embodiment of the present invention, the concentration of the real extract concentration is preferably 1 (w/w)% or more, more preferably 2 (w/w)% or more, even more preferably 3 (w/w)% or more, further preferably 4 (w/w)% or more, still further preferably 5 (w/w)% or more, still further preferably 6 (w/w)% or more, still further preferably 6.5 (w/w)% or more, still further preferably 7 (w/w)% or more, and particularly preferably 7.5 (w/w)% or more. The concentration of the real extract concentration may also be 7.7 (w/w)% or more, 7.8 (w/w)% or more, 7.9 (w/w)% or more, or 8.0 (w/w)% or more. On the other hand, in the beer-taste beverage according to one embodiment of the present invention, the real extract concentration is preferably 10 (w/w)% or less, more preferably 9.5 (w/w)% or less, even more preferably 9 (w/w)% or less, further preferably 8.5 (w/w)% or less, still further preferably 8.4 (w/w)% or less, still further preferably 8.3 (w/w)% or less, and still further preferably 8.2 (w/w)% or less.

The concentration of the real extract can be measured according to the method described in “8.4.3 Alcolyzer Method” in “Revised Version Brewery Convention of Japan (BCOJ) Beer Analysis Method, Enlarged and Revised in 2013 (the Brewing Society of Japan),” edited by Brewers Association of Japan, Brewery Convention of Japan [Analysis Committee].

The concentration of the real extract can be adjusted by determining, as appropriate, addition of a diluting solution or carbonated water, the types of raw materials (malts, corn grits, a sugar solution, etc.), the granularity of milled malts, the style of milling malts (wet milling, dry milling, etc.), the humidity applied upon the milling of malts (the degree of humidity control), the temperature applied upon the milling of malts, the type of a mill used in malt milling, the amounts of the raw materials, the type of an enzyme, the additive amount of the enzyme, the timing of adding the enzyme, the enzymatic decomposition time, the saccharification time in a preparation tank, the proteolysis time in the preparation tank, the pH in the preparation tank, the pH in a preparation step (a wort-producing step after addition of the malts and before addition of the yeast), the additive amount of an acid used upon the pH adjustment, the timing of the pH adjustment (at the time of preparation, during fermentation, at completion of the fermentation, before beer filtration, after beer filtration, etc.), the preset temperature in each temperature range and retention time during preparation of a wort (including during saccharification), the time for wort filtration, the temperature for wort filtration, the pH applied upon wort filtration, the amount of wort recovered by wort filtration, the amount of sparging water upon wort filtration, the pH of the sparging water upon wort filtration, the temperature of the sparging water upon wort filtration, fermentation conditions (oxygen concentration, aeration conditions, the variety of the yeast, the additive amount of the yeast, the number of proliferating yeast cells, the timing of removing the yeast, fermentation temperature, fermentation time, pressure setting, carbon dioxide concentration, etc.), addition of spirits, distilled alcohols and the like, etc.

From the viewpoint of improving a clean aftertaste and also improving a feeling of fermentation, the beer-taste beverage according to one embodiment of the present invention preferably comprises maltose.

In the beer-taste beverage according to one embodiment of the present invention, the upper limit of the content of maltose is preferably 6.0% by mass or less, more preferably 5.5% by mass or less, even more preferably 5.0% by mass or less, further preferably 4.0% by mass or less, still further preferably 3.0% by mass or less, still further preferably 2.5% by mass or less, and particularly preferably 2.0% by mass or less. On the other hand, the lower limit of the content of maltose in the present beer-taste beverage is preferably 0.3% by mass or more, more preferably 0.4% by mass or more, even more preferably 0.5% by mass or more, and particularly preferably 0.6% by mass or more.

In the present description, the content of maltose can be measured by high performance liquid chromatography (HPLC).

The content of maltose can be adjusted by determining, as appropriate, addition of a diluting solution or carbonated water, the types of raw materials (malts, corn grits, a sugar solution, etc.), the granularity of milled malts, the style of milling malts (wet milling, dry milling, etc.), the humidity applied upon the milling of malts (the degree of humidity control), the temperature applied upon the milling of malts, the type of a mill used in malt milling, the amounts of the raw materials, the type of an enzyme, the additive amount of the enzyme, the timing of adding the enzyme, the enzymatic decomposition time, the saccharification time in a preparation tank, the pH in the preparation tank, the pH in a preparation step (a wort-producing step after addition of the malts and before addition of the yeast), the additive amount of an acid used upon the pH adjustment, the timing of the pH adjustment (at the time of preparation, during fermentation, at completion of the fermentation, before beer filtration, after beer filtration, etc.), the preset temperature in each temperature range and retention time during preparation of a wort (including during saccharification), the time for wort filtration, the temperature for wort filtration, the pH applied upon wort filtration, the amount of wort recovered by wort filtration, the amount of sparging water upon wort filtration, the pH of the sparging water upon wort filtration, the temperature of the sparging water upon wort filtration, the concentration of an original extract in a pre-fermentation solution, the concentration of an original extract in a fermentation step, fermentation conditions (oxygen concentration, aeration conditions, the variety of the yeast, the additive amount of the yeast, the number of proliferating yeast cells, the timing of removing the yeast, fermentation temperature, fermentation time, pressure setting, carbon dioxide concentration, etc.), and the like.

In general, a beer-taste beverage having a lower content of ethanol than a common beer-taste beverage is likely to have a low content of organic acid obtained by fermentation, and thus, such a beverage is likely to lack a beer-like clean aftertaste. However, the beer-taste beverage according to one embodiment of the present invention can have such a beer-like clean aftertaste by setting the pH value thereof to be pH 2.6 to 4.1.

The upper limit of the pH of the beer-taste beverage is preferably less than 4.0, more preferably 3.9 or less, even more preferably 3.8 or less, further preferably 3.7 or less, and particularly preferably 3.6 or less. On the other hand, the lower limit of the pH of the beer-taste beverage is preferably 2.7 or more, more preferably 2.8 or more, even more preferably 3.0 or more, further preferably 3.1 or more, still further preferably 3.2 or more, and particularly preferably 3.3 or more.

The pH of the beer-taste beverage can be adjusted by determining, as appropriate, addition of a diluting solution or carbonated water, the types of raw materials (malts, corn grits, a sugar solution, etc.), the amounts of the raw materials, the type of an enzyme, the additive amount of the enzyme, the timing of adding the enzyme, the saccharification time in a preparation tank, the proteolysis time in the preparation tank, the pH in the preparation tank, the pH in a preparation step (a wort-producing step after addition of the malts and before addition of the yeast), the type of an acid used upon the pH adjustment (lactic acid, phosphoric acid, malic acid, tartaric acid, citric acid, etc.), the additive amount of an acid used upon the pH adjustment, the timing of the pH adjustment (at the time of preparation, during fermentation, at completion of the fermentation, before beer filtration, after beer filtration, etc.), the preset temperature in each temperature range and retention time during preparation of a wort (including during saccharification), the concentration of an original extract in a pre-fermentation solution, the concentration of an original extract in a fermentation step, fermentation conditions (oxygen concentration, aeration conditions, the variety of the yeast, the additive amount of the yeast, the number of proliferating yeast cells, the timing of removing the yeast, fermentation temperature, fermentation time, pressure setting, carbon dioxide concentration, etc.), and the like.

The color of the beer-taste beverage according to one embodiment of the present invention is not particularly limited. The beer-taste beverage according to one embodiment of the present invention may have an amber or golden color, such as those of ordinary beer, or may have a black color such as that of black beer, or may also be colorless and transparent. Otherwise, a desired color may be imparted to the beer-taste beverage by adding a coloring agent or the like thereto. The color of the beverage can be determined with the unaided eye, but it may also be determined using total light transmittance, chromaticity, etc.

The beer-taste beverage according to one embodiment of the present invention may have an embodiment in which the beverage is filled in a container. Examples of the container may include bottles, plastic bottles, cans, and barrels. From the viewpoint of, in particular, the ease of carrying, cans, bottles and plastic bottles are preferable.

1.1 Raw Materials

As main raw materials of the beer-taste beverage according to one embodiment of the present invention, malts may be or may not be used together with water. In addition, hops may also be used, and further, distilled liquor, a sweetener, water-soluble dietary fibers, a bittering agent or a bitterness-imparting agent, an antioxidant, a flavor, a sourness-imparting substance, and the like may also be used.

When malts are used as raw materials, the malts mean those obtained by germinating the seeds of mugi plants such as barley, wheat, rye, wild oats, oats, adlay, or Avena sativa, then drying them, and then removing roots. The production area and variety of the used malts are not particularly limited.

In one embodiment of the present invention, the used malts are preferably barley malts. The barley malts are one type of malts that are most commonly used as raw materials of beer-taste beverages in Japan. Barley has several types such as two-row barley and six-row barley. All types of barley may be used. Further, in addition to common malts, colored malts and the like can also be used. When such colored malts are used, different types of colored malts may be appropriately used in combination, or only one type of colored malts may also be used.

Moreover, together with malts, grains other than the malts may also be used. Examples of such grains may include mugi that does not correspond to malts (e.g. barley, wheat, rye, wild oats, oats, adlay, Avena sativa, etc.), rice (e.g. white rice, brown rice, etc.), corn, kaoliang, potato, beans (e.g. soybeans, garden peas, etc.), buckwheat, sorghum, foxtail millet, barnyard millet, starches obtained from these grains, and extracts thereof.

When malts are not used as raw materials of the beer-taste beverage, liquid sugar containing a carbon source, and a nitrogen source serving as an amino acid-containing material, such as the aforementioned grains other than malts, are preferably used.

Examples of the forms of hops used in one embodiment of the present invention may include pelletized hops, powdered hops, and hop extracts. In addition, the used hops may also be hop-processed products such as isomerized hops and reduced hops.

The additive amount of such hops is adjusted, as appropriate. The additive amount of the hops is preferably 0.0001% to 1% by mass, with respect to the total amount of the beverage.

The beer-taste beverage according to one embodiment of the present invention may comprise, as an alcohol component, previously prepared distilled liquor. Examples of such distilled liquor may include, but are not particularly limited to, raw material alcohol, spirits, vodka, rum, tequila, gin, and shochu.

Herein, the spirits mean alcohols obtained by using, as raw materials, grains such as mugi, rice, buckwheat or corn, saccharifying the raw material grains using malts, or as necessary, an enzyme agent, then fermenting the resultants using yeasts, and then distilling the fermented products.

Examples of the sweetener may include commercially available saccharified solution obtained by decomposing grain-derived starch with an acid, an enzyme or the like, commercially available sugars such as starch syrup, sugar that is trisaccharide or more, sugar alcohol, natural sweeteners such as stevia, and artificial sweeteners.

The form of these sugars may be either a liquid such as a solution, or a solid such as powders.

Moreover, the types of raw material grains for starch, the method of purifying starch, and treatment conditions, such as hydrolysis with an enzyme or an acid, are not particularly limited. For example, conditions for hydrolysis with an enzyme or an acid are determined, as appropriate, so that sugars in which the ratio of maltose is increased may be used. Furthermore, sucrose, fructose, glucose, maltose, trehalose, maltotriose, a solution thereof (i.e. a sugar solution) or the like can also be used.

Further, examples of the artificial sweetener may include aspartame, acesulfame potassium (acesulfame K), and sucralose.

Examples of the water-soluble dietary fibers may include indigestible dextrin, polydextrose, partially hydrolyzed guar gum, pectin, glucomannan, alginic acid, laminarin, fucoidin, and carrageenan. From the viewpoint of versatility such as stability and safety, indigestible dextrin or polydextrose is preferable.

In the beer-taste beverage according to one embodiment of the present invention, bitterness is preferably imparted with hops or the like. Together with or instead of such hops, a bittering agent or a bitterness-imparting agent may also be used.

The bittering agent or the bitterness-imparting agent is not particularly limited, and substances used as bitterness imparting agents in ordinary beer or low-malt beer can be used. Examples thereof may include Artemisia absinthium, Ganoderma lucidum, Litchi chinensis, Carum carvim, juniper fruit, sage, rosemary, reishi mushroom, laurel, quasin, naringin, absinthine, Artemisia absinthium extract, citrus extract, Picrasma quassioides extract, coffee extract, tea extract, bitter melon extract, lotus germ extract, Aloe arborescens extract, Ganoderma lucidum extract, Litchi chinensis extract, laurel extract, sage extract, and caraway extract.

The antioxidant is not particularly limited, and substances used as antioxidants in ordinary beer or low-malt beer can be used. Examples thereof may include ascorbic acid, erythorbic acid, and catechin.

The flavor is not particularly limited, and common beer flavor can be used. Such a beer flavor is used to add a beer-like flavor to the beverage.

Examples of the beer flavor may include ester and higher alcohol. Specific examples of the beer flavor may include ethyl acetate, isoamyl acetate, n-propanol, isobutanol, ethyl caproate, 4-vinylguaiacol, and acetaldehyde.

The beer-taste beverage according to one embodiment of the present invention may also comprise a sourness-imparting substance other than lactic acid and phosphoric acid. By using another sourness-imparting substance, the feeling of fermentation and clean aftertaste of the beverage can be further improved.

The sourness-imparting substance other than lactic acid and phosphoric acid is not particularly limited, as long as it is a substance that imparts sourness to the present beer-taste beverage. Examples of the sourness-imparting substance that can be used herein may include citric acid, gluconic acid, malic acid, phytic acid, acetic acid, succinic acid, tartaric acid, pyruvic acid, pyroglutamic acid, brewed vinegar, and salts thereof. Among these sourness-imparting substances, citric acid, tartaric acid, brewed vinegar, and salts thereof are preferable, and brewed vinegar is more preferable. In addition, as such sourness-imparting substances, two or more components may also be used in combination.

From the viewpoint of improving a clean aftertaste, with regard to the content of all of the sourness-imparting substances in the beer-taste beverage according to one embodiment of the present invention, the sourness-imparting substances preferably have an acidity of 0.01% to 0.4%. The “acidity” means a value calculated based on the method of measuring acidity defined by Japanese Agricultural Standards (Nosui Koku No. 1127; Aug. 8, 2006).

1.2 Carbon Dioxide Gas

Carbon dioxide gas contained in the beer-taste beverage according to one embodiment of the present invention may be added to the beer-taste beverage by mixing with carbonated water, or the carbon dioxide gas may also be directly added to a raw material solution.

The concentration of the carbon dioxide gas in the beer-taste beverage of the present invention is preferably 0.30 (w/w)% or more, more preferably 0.35 (w/w)% or more, further preferably 0.40 (w/w)% or more, still further preferably 0.42 (w/w)% or more, and particularly preferably 0.45 (w/w)% or more. On the other hand, the concentration of the carbon dioxide gas in the beer-taste beverage of the present invention is preferably 0.80 (w/w)% or less, more preferably 0.70 (w/w)% or less, further preferably 0.60 (w/w)% or less, still further preferably 0.57 (w/w)% or less, and particularly preferably 0.55 (w/w)% or less.

Besides, in the present description, the concentration of the carbon dioxide gas can be measured by immersing a container containing the beverage as a target in a water tank at 20° C. for 30 minutes or more, while shaking the container sometimes, so that the temperature of the beverage is adjusted to 20° C., and then measuring the carbon dioxide gas concentration using a gas volume measuring device (for example, GVA-500 (manufactured by KYOTO ELECTRONICS MANUFACTURING CO., LTD.), etc.).

The amount of the carbon dioxide gas contained in the beer-taste beverage is indicated with the carbon dioxide gas pressure of the beverage. However, the amount of the carbon dioxide gas is not particularly limited, as long as it does not impair the effects of the present invention. Typically, the upper limit of the carbon dioxide gas pressure of the beverage is 5.0 kg/cm², 4.5 kg/cm², or 4.0 kg/cm₂, and the lower limit thereof is 0.20 kg/cm², 0.50 kg/cm², or 1.0 kg/cm². All of these upper limits and lower limits may be combined with one another. For instance, the carbon dioxide gas pressure of the beverage may be 0.20 kg/cm² or more and 5.0 kg/cm² or less, 0.50 kg/cm² or more and 4.5 kg/cm² or less, or 1.0 kg/cm² or more and 4.0 kg/cm² or less.

In the present description, the gas pressure means a gas pressure in a container, unless otherwise specified.

The pressure can be measured by a method well known to a person skilled in the art, and for example, the pressure can be measured by applying a method comprising fixing a sample set at 20° C. in a gas pressure gauge, then once opening the stopper cock of the gas pressure gauge to discharge gas, then closing the stopper cock again, then shaking the gas pressure gauge, and then reading the value when the indicator reaches a predetermined position, or by using a commercially available gas pressure measurement device.

1.3 Other Additives

The beer-taste beverage according to one embodiment of the present invention may comprise various additives, as necessary, to such an extent that the additives do not impair the effects of the present invention.

Examples of such additives may include coloring agents, foaming agents, fermentation promoters, yeast extracts, protein substances such as peptide-containing matters, and condiments such as amino acids.

The coloring agent is used to impart a beer-like color to the beverage, and a caramel coloring or the like can be used. The foaming agent is used to form beer-like foams or to retain the foams of the beverage. Examples of the foaming agent that can be appropriately used herein may include: plant-extracted saponin substances such as soybean saponin and quillaja saponin; vegetable proteins of corns, soybeans, and the like; protein substances such as a peptide-containing matter and bovine serum albumin; and yeast extracts.

The fermentation promoter is used to promote fermentation with yeasts. For example, yeast extracts, bran ingredients of rice, mugi, and the like, vitamins, and mineral agents can be used alone or in combination.

Moreover, as such additives, benzoic acid, benzoate such as sodium benzoate, or dimethyl dicarbonate may also be added.

2. Method for Producing Beer-Taste Beverage

The beer-taste beverage according to one embodiment of the present invention includes a fermented beer-taste beverage produced by a production method comprising a fermentation step and a non-fermented beer-taste beverage produced by a production method that does not comprise a fermentation step.

Hereafter, a method for producing a fermented beer-taste beverage and a method for producing a non-fermented beer-taste beverage will be described.

2.1 Method for Producing Fermented Beer-Taste Beverage

The method for producing a fermented beer-taste beverage according to one embodiment of the present invention is not particularly limited, and it is, for example, a method comprising the following Steps (1) and (2).
Step (1): a step of subjecting a mixture comprising various raw materials such as water and malts to a saccharification treatment to prepare a fermentation raw material solution.
Step (2): a step of adding a yeast to the fermentation raw material solution and performing alcoholic fermentation.

Moreover, the method for producing a fermented beer-taste beverage according to one embodiment of the present invention may further comprise one or more of the following Steps (3) to (6), as necessary.
Step (3): a step of adjusting the content of diacetyl.
Step (4): a step of adjusting the content of H₂S.
Step (5): a step of adjusting the content of ethanol.
Step (6): a step of adjusting the content of lactic acid and/or the content of phosphoric acid.

The above-described individual steps will be described below.

<Step (1)>

Step (1) is a step of subjecting a mixture comprising various types of raw materials such as water and malts to a saccharification treatment to prepare a fermentation raw material solution.

As raw materials, grains are preferably used, and mugi and malts are more preferably used. The ratio of the used malts is not particularly limited. The upper limit value of the ratio of the used malts is 100% or less, preferably 90% or less, more preferably 80% or less, further preferably 70% or less, and still further preferably 60% or less. On the other hand, the lower limit value thereof is preferably adjusted to become preferably 10% or less, more preferably 15% or less, further preferably 17.5% or less, still further preferably 20% or less, and particularly preferably 22.5% or more.

The method of preparing a fermentation raw material solution may be, for example, a method comprising adding raw materials such as water and malts into a preparation pot or a preparation tank, then adding, as necessary, enzymes such as amylase into the pot or the tank to prepare a mixture, and then subjecting the obtained mixture to a saccharification treatment, so as to obtain a fermentation raw material solution. Thereafter, it is preferable that the obtained fermentation raw material solution is filtrated and boiled, and that solids such as coagulated proteins are removed from the solution in a clarification tank.

Moreover, as a mixture to be subjected to a saccharification treatment, hops, dietary fibers, sweeteners, antioxidants, bitterness-imparting agents, flavors, sourness-imparting substances, pigments, etc., may also be added, other than water and malts.

These substances may be added to the mixture before performing the saccharification treatment, or may be added during the saccharification treatment, or may also be added after completion of the saccharification treatment. Furthermore, these substances may also be added after completion of the subsequent alcoholic fermentation step.

In the present step, the above-described mixture formed by adding the raw materials is heated, so that starchy materials in the raw materials are saccharified.

The temperature and the time applied in the saccharification treatment are adjusted, as appropriate, depending on the types of malts used, the ratio of malts, raw materials other than water and malts, the type and amount of an enzyme used, etc.

<Step (2)>

Step (2) is a step of adding a yeast into the fermentation raw material solution obtained by performing the saccharification treatment in Step (1), and then performing alcoholic fermentation.

The yeast used in the present step can be selected, as appropriate, while taking into consideration the type of a fermented beverage to be produced, a desired flavor, fermentation conditions, etc. Either a top fermentation yeast or a bottom fermentation yeast may be used, but it is preferable to use a bottom fermentation yeast.

The yeast may be directly added as a yeast suspension into the fermentation raw material solution. Otherwise, a slurry obtained by concentrating the yeast according to centrifugation or precipitation may be added into the fermentation raw material solution. Alternatively, after completion of the centrifugation, a residue obtained by completely removing a supernatant from the slurry may also be added. The additive amount of the yeast into the fermentation raw material solution can be determined, as appropriate, and it is preferably 40×10⁶ cells/ml or more, and more preferably 40×10⁶ cells/ml to 1×10⁸ cells/ml.

The fermentation conditions applied upon the alcoholic fermentation can be determined, as appropriate. The fermentation conditions are preferably determined, so that the ethanol content in the finally obtained beer-taste beverage can become 0.4 (v/v)% or more and less than 1.5 (v/v)%, the diacetyl content therein can become less than 0.07 ppm by mass, and the H₂S content therein can become less than 5 ppb by mass.

If the fermentation speed is fast, the content of ethanol is increased. Thus, it is preferable that fermentation is carried out at a lower temperature than usual. The fermentation temperature is preferably 21° C. or lower, more preferably 15° C. or lower, even more preferably 9° C. or lower, further preferably 5° C. or lower, still further preferably 4° C. or lower, still further preferably 3° C. or lower, still further preferably 2° C. or lower, still further preferably 1.75° C. or lower, and particularly preferably 1.5° C. or lower. On the other hand, the fermentation temperature is preferably 1° C. or higher.

In addition, if the fermentation time exceeds a predetermined period of time, the content of ethanol is increased, and generation of H₂S and diacetyl is increased. Thus, it is preferable to perform the fermentation in a shorter time than usual. The lower limit value of the fermentation time is preferably 1 hour or more, more preferably 5 hours or more, even more preferably 15 hours or more, further preferably 20 hours or more, still further preferably 25 hours or more, still further preferably 30 hours or more, and particularly preferably 35 hours or more. On the other hand, the upper limit value of the fermentation time is preferably 720 hours or less, more preferably 480 hours or less, even more preferably 360 hours or less, further preferably 240 hours or less, and particularly preferably 200 hours or less.

After completion of the alcoholic fermentation in Step (2), the yeast is removed by using a filtration machine or the like.

Before and after the alcoholic fermentation step, a step of adding water and additives such as a flavor, a sourness-imparting substance and a pigment may be established, as necessary. In addition, in such a step of adding water and additives such as a flavor, a sourness-imparting substance and a pigment, the content of maltose, the concentration of the original extract, the concentration of the real extract, etc. may be adjusted.

After completion of the alcoholic fermentation step, ethanol is removed, so that the content of ethanol can be reduced.

<Step (3), Step (4), Step (5), and Step (6)>

Step (3), Step (4), Step (5), and Step (6) may be carried out during Step (1) or Step (2), or before or after Step (2) performed after completion of Step (1). However, from the viewpoint of precisely adjusting the contents of the substances in the finally produced beverage, Step (3), Step (4), Step (5), and Step (6) are preferably carried out after completion of Step (1) and before initiation of Step (2).

Besides, the order of performing Step (3), Step (4), Step (5), and Step (6) is not particularly limited, and any of these steps may be carried out first.

In Step (3), it is preferable that the content of diacetyl in the beverage before adjustment is measured, and that based on the measured value, diacetyl or a raw material containing diacetyl is added, or water or carbonated water, etc. is added to the beverage to dilute it, so that the content of diacetyl can be adjusted to be in the aforementioned range. Diacetyl is generated in the fermentation step. Thus, it is preferable to adjust the content of diacetyl by terminating the fermentation in the midway thereof in Step (2).

Besides, when the content of diacetyl has already been in a desired range because of the presence of diacetyl derived from raw materials in the beverage before adjustment, the operation of adding diacetyl or adding water to the beverage to dilute it according to the present step is unnecessary.

In Step (4), it is preferable that the content of H₂S in the beverage before adjustment is measured, and that based on the measured value, water or carbonated water, etc. is added to the beverage to dilute it, so that the content of H₂S can be adjusted to be in the aforementioned range. H₂S is generated in the fermentation step. Thus, it is preferable to adjust the content of H₂S by terminating the fermentation in the midway thereof in Step (2).

Besides, when the content of H₂S has already been in a desired range because of the presence of H₂S derived from raw materials in the beverage before adjustment, the operation of adding water or carbonated water to the beverage to dilute it according to the present step is unnecessary.

In Step (5), the content of ethanol can be adjusted by controlling the fermentation conditions in Step (2), or by adding a raw material containing ethanol, such as distilled liquor. It is preferable to adjust the content of ethanol by terminating the fermentation in the midway thereof in Step (2). Otherwise, water or carbonated water, etc. is added to the beverage to dilute it, so that the content of ethanol may be adjusted.

In Step (6), it is preferable that the contents of lactic acid and phosphoric acid in the beverage before adjustment are measured, and that based on the measured values, lactic acid, phosphoric acid, or the two acids are added to the beverage, or water is added to the beverage to dilute it, so that the content of lactic acid and the content of phosphoric acid are adjusted to be in desired ranges. Besides, when the content of lactic acid and the content of phosphoric acid in the beverage before adjustment are in desired ranges, the adjustment according to the present step is unnecessary.

The thus obtained beer-taste beverage is filled in a predetermined container, and is distributed as a product to the market.

The method of filling the beer-taste beverage in a container is not particularly limited, and a method of filling a beverage in a container that is well known to those skilled in the art can be applied. By performing a step of filling a beer-taste beverage in a container, the beer-taste beverage is filled and hermetically sealed in the container. In such a step of filling a beer-taste beverage in a container, containers having any forms and/or being made of any materials may be used, and examples of such a container are those as described above.

2.2 Method for Producing Non-Fermented Beer-Taste Beverage

The method for producing a non-fermented beer-taste beverage according to one embodiment of the present invention is not particularly limited, and it is, for example, a method comprising the following Steps (1) and (2).
Step (1): a step of performing at least one treatment of a saccharification treatment, a boiling treatment and a solid-removing treatment, using various types of raw materials, so as to obtain a pre-beverage solution.
Step (2): a step of adding carbon dioxide gas to the pre-beverage solution.

Moreover, the method for producing a non-fermented beer-taste beverage according to one embodiment of the present invention may further comprise one or more of the following Steps (3) to (5), as necessary.
Step (3): a step of adjusting the content of diacetyl.
Step (4): a step of adjusting the content of ethanol.
Step (5): a step of adjusting the content of lactic acid and/or the content of phosphoric acid.

The above-described individual steps will be described below.

<Step (1)>

Step (1) is a step of performing at least one treatment of a saccharification treatment, a boiling treatment and a solid-removing treatment, using various types of raw materials, so as to obtain a pre-beverage solution.

For example, when malts are used as various types of raw materials, various types of raw materials including water and malts are added into a preparation pot or a preparation tank, and enzymes such as amylase are added, as necessary. Various types of raw materials other than the malts that may be added herein may include hops, dietary fibers, sweeteners, antioxidants, bittemess-imparting agents, flavors, sourness-imparting substances, and pigments.

A mixture of various types of raw materials is heated, and starchy materials in the raw materials are saccharified, so as to carry out a saccharification treatment. The temperature and the time applied in the saccharification treatment are adjusted, as appropriate, depending on the types of malts used, the ratio of malts, raw materials other than water and malts, etc. Filtration is carried out after completion of the saccharification treatment, so as to obtain a saccharified solution.

Besides, this saccharified solution is preferably subjected to a boiling treatment.

When hops, bittering agents, etc. are used as raw materials, these substances are preferably added in this boiling treatment. Hops, bittering agents, etc. may be added at a timing between initiation of the boiling of the saccharified solution and before termination of the boiling.

Thereafter, a solid-removing treatment is carried out in a clarification tank in order to remove solids such as coagulated proteins from the saccharified solution. Thus, a pre-beverage solution is obtained.

Besides, hops, bittering agents, etc. may be added into a malt extract to which hot water has been added, instead of the above-described saccharified solution, and a boiling treatment may be then carried out to prepare a pre-beverage solution.

On the other hand, when malts are not used as various types of raw materials, liquid sugar containing a carbon source, a nitrogen source serving as an amino acid-containing material other than mugi or malts, hops, dietary fibers, sweeteners, antioxidants, bitterness-imparting agents, flavors, sourness-imparting substances, pigments, etc. may be mixed with hot water to prepare a liquid sugar solution, and a boiling treatment may be then carried out on the liquid sugar solution, thereby preparing a pre-beverage solution.

In the case of using hops, such hops may be added before performing the boiling treatment, or may also be added at the timing between initiation of the boiling of the liquid sugar solution and before termination of the boiling.

On the other hand, the production method according to one embodiment of the present invention may also be a method in which the above-described fermentation step and alcohol-removing step are not carried out.

<Step (2)>

Step (2) is a step of adding carbon dioxide gas to the above-described pre-beverage solution. As a method of adding carbon dioxide gas, a known method applied upon the production of a carbonated beverage can be used. Using such a known method, it is preferable to adjust the carbon dioxide gas pressure to be in the aforementioned range.

<Step (3), Step (4), and Step (5)>

Step (3), Step (4), and Step (5) may be carried out at any timing of, before or after the saccharification treatment, before or after the boiling treatment, and before or after the solid-removing treatment in Step (1), or may also be carried out before or after Step (2) performed after completion of the Step (1). However, from the viewpoint of precisely adjusting the contents of the substances in the finally produced beverage, Step (3), Step (4), and Step (5) are preferably carried out after completion of Step (1) and before initiation of Step (2).

Besides, the order of performing Step (3), Step (4), and Step (5) is not particularly limited, and any of these steps may be carried out first.

In Step (3), it is preferable that the content of diacetyl in the beverage before adjustment is measured, and that based on the measured value, diacetyl or a raw material containing diacetyl is added, or water is added to the beverage to dilute it, so that the content of diacetyl can be adjusted to be in the aforementioned range. Besides, when the content of diacetyl has already been in a desired range because of the presence of diacetyl derived from raw materials in the beverage before adjustment, the operation of adding diacetyl or adding water to the beverage to dilute it according to the present step is unnecessary.

In Step (4), the content of ethanol is adjusted, for example, by adding a raw material containing ethanol, such as distilled liquor.

Step (5) is the same as Step (6) of the method for producing a fermented beer-taste beverage.

After completion of these steps, steps performed in the production of a beer-taste beverage that are well known to those skilled in the art, such as a liquor storage step and a filtration step, may be carried out.

The method of filling the beer-taste beverage into a container is the same as that applied in the above-described method for the producing a fermented beer-taste beverage.

### EXAMPLES

Hereinafter, the present invention will be described in more detail in the following Examples. However, these examples are not intended to limit the scope of the present invention.

<Preparation of Beverages>

Pulverized barley malts and polysaccharide degrading enzymes were added into a preparation tank filled with 100 L of hot water retained at 52° C. Thereafter, the temperature was gradually increased, while the mixture was retained in a temperature range of 45° C. to 55° C. for 5 minutes to 120 minutes, and then in a temperature range of 60° C. to 85° C. for 5 minutes to 120 minutes, thereby preparing a saccharified solution. For example, in Example 1, the mixture was retained at 52° C. for 40 minutes, and then was retained at 80° C. for 40 minutes, so that the temperature was gradually increased.

Thereafter, lactic acid and phosphoric acid were added to the saccharified solution, so that the content of the lactic acid and the content of the phosphoric acid in the beverage became those shown in Table 1 and Table 2. Thereafter, the obtained mixture was filtrated, and malt lees was removed to obtain a wort. To the obtained wort, liquid sugar and water were added to achieve the concentration of the real extract shown in Table 1 and Table 2, and hops were further added to the obtained mixture, followed by boiling. After completion of the boiling, the wort was subjected to a solid-liquid separation treatment, and the thus obtained clear wort was then cooled. After that, a yeast was added to the wort, and then, the fermentation temperature, the fermentation time, the additive amount of the polysaccharide degrading enzyme, and the timing of addition of the enzyme were adjusted, so that the content of maltose, the content of ethanol, the content of H₂S, and the content of diacetyl shown in Table 1 and Table 2 could be achieved, thereby preparing a fermented solution. The fermented solution was filtrated, so that each beverage to be tested that was a beer could be prepared. For example, in Example 1, fermentation was performed at a fermentation temperature of 1.0° C. and at a number of yeast cells added of 60×10⁶ cells/mL for about 40 hours, and thereafter, it was confirmed that the content of H₂S was less than 5 ppm by mass and the content of diacetyl was less than 0.07 ppm by mass. Thereafter, filtration was performed.

It is to be noted that, in individual Examples and Comparative Examples, fermentation conditions such as the type of an enzyme, the additive amount of the enzyme, the timing of addition of the enzyme, the preset temperature in each temperature range upon preparation of the saccharified solution, the retention time, the fermentation temperature, and the fermentation time were determined, as appropriate, and then that the fermentation conditions were each adjusted, so that the content of maltose, the content of ethanol, the content of H₂S, the content of diacetyl, and the concentration of the real extract, which are shown in Table 1 and Table 2, could be achieved.

<Sensory Evaluation>

With regard to the obtained beverages, 6 panelists who had been trained on a daily basis performed sensory evaluation on individual beverages cooled to about 4° C. In Examples 1 to 6 and Comparative Examples 1 and 2, the relationship between the contents of lactic acid and phosphoric acid and “sourness unsuitable for beer-taste beverages” was examined. In addition, in Examples 7 to 12 and Comparative Examples 3 to 5, the relationship between the contents of diacetyl, H₂S and the like, and “feeling of fermentation suitable for beer-taste beverages” and “cosmetic fragrance unsuitable for beer-taste beverages” was examined.

With regard to the “sourness unsuitable for beer-taste beverages,” the “feeling of fermentation suitable for beer-taste beverages” and the “cosmetic fragrance unsuitable for beer-taste beverages,” evaluation was carried out based on the following score criteria, with scores in 0.1 steps in the range of 3 (maximum value) to 1 (minimum value), and the mean value of the scores by the 6 panelists was then calculated. The results are shown in Table 1 and Table 2.

For the evaluation, samples whose “sourness unsuitable for beer-taste beverages” corresponded to the following criteria “1,” “2,” and “3”; samples whose “feeling of fermentation suitable for beer-taste beverages” corresponded to the following criteria “1,” “2,” and “3”; and samples whose “cosmetic fragrance unsuitable for beer-taste beverages” corresponded to the following criteria “1,” “2,” and “3,” had previously been prepared, and thus, the standards among individual panelists were intended to be unified. Moreover, in both of the sensory evaluations shown in Table 1 and Table 2, a score value difference of 2.0 or more was not found among individual panelists, with respect to an identical beverage.

### [Sourness Unsuitable for Beer-Taste Beverages] (Examples 1 to 6 and Comparative Examples 1 and 2)

“3”: Not felt.
“2”: Hardly felt.
“1”: Felt.

Then, based on the mean value of the scores of the 6 panelists, the sourness unsuitable for beer-taste beverages was evaluated for each beverage according to the following criteria, and a beverage having a score of 2.0 or more was determined to be satisfactory.

### [Feeling of Fermentation Suitable for Beer-Taste Beverages] (Examples 7 to 12 and Comparative Examples 3 to 5)

“3”: Excellent.
“2”: Favorable.
“1”: Poor.

Then, based on the mean value of the scores of the 6 panelists, the feeling of fermentation suitable for beer-taste beverages was evaluated for each beverage according to the following criteria, and a beverage having a score of 2.0 or more was determined to be satisfactory.

### [Cosmetic Fragrance Unsuitable for Beer-Taste Beverages] (Examples 7 to 12 and Comparative Examples 3 to 5)

“3”: Not felt.
“2”: Hardly felt.
“1”: Felt.

Then, based on the mean value of the scores of the 6 panelists, the cosmetic fragrance unsuitable for beer-taste beverages was evaluated for each beverage according to the following criteria, and a beverage having a score of 2.0 or more was determined to be satisfactory.

### [Comprehensive Evaluation of Beer-Taste Beverages] (Examples 7 to 12 and Comparative Examples 3 to 5)

Based on the “feeling of fermentation suitable for beer-taste beverages” and the “cosmetic fragrance unsuitable for beer-taste beverages” felt when individual panelists tasted the beverages, comprehensive evaluation was carried out in 3 grades according to the following criteria.
“A”: Evaluation of both the “feeling of fermentation suitable for beer-taste beverages” and the “cosmetic fragrance unsuitable for beer-taste beverages” is 2.5 or more.
“C”: Evaluation of either the “feeling of fermentation suitable for beer-taste beverages” or the “cosmetic fragrance unsuitable for beer-taste beverages” is less than 2.
“B”: Evaluation does not correspond to “A” and “C.”

TABLE 1

| | Ex. 1 | Ex. 2 | Ex. 3 | Ex. 4 | Ex. 5 | Ex. 6 | Comp. Ex. 1 | Comp. Ex. 2 |
|---|---|---|---|---|---|---|---|---|
| Fermentation temperature (° C.) | 1.0 | 1.0 | 1.0 | 1.0 | 1.0 | 1.0 | 1.0 | 1.0 |
| Number of yeast cells added (×10⁶ cells/mL) | 60 | 60 | 60 | 60 | 60 | 60 | 60 | 60 |
| Real extract (w/w %) | 7.85 | 7.85 | 7.85 | 7.85 | 7.85 | 7.85 | 7.85 | 7.85 |
| Lactic acid (ppm by mass) | 160 | 100 | 100 | 949 | 949 | 769 | 1300 | 949 |
| Phosphoric acid (ppm by mass) | 170 | 120 | 894 | 120 | 450 | 894 | 894 | 1200 |
| Lactic acid + Phosphoric acid (ppm by mass) | 330 | 220 | 994 | 1069 | 1399 | 1663 | 2194 | 2149 |
| Ethyl acetate (ppm by mass) | 1.8 | 1.8 | 1.8 | 1.8 | 1.8 | 1.8 | 1.8 | 1.8 |
| Isoamyl acetate (ppm by mass) | 0.2 | 0.2 | 0.2 | 0.2 | 0.2 | 0.2 | 0.2 | 0.2 |
| Ethanol (v/v %) | 0.74 | 0.74 | 0.74 | 0.74 | 0.74 | 0.74 | 0.74 | 0.74 |
| H₂S (ppb by mass) | 2.9 | 2.9 | 2.9 | 2.9 | 2.9 | 2.9 | 2.9 | 2.9 |
| Diacetyl (ppm by mass) | 0.06 | 0.06 | 0.06 | 0.06 | 0.06 | 0.06 | 0.06 | 0.06 |
| Maltose (% by mass) | 1.9 | 1.9 | 1.9 | 1.9 | 1.9 | 1.9 | 1.9 | 1.9 |
| Sourness unsuitable for beer-flavored beverages | 2.9 | 3.0 | 2.4 | 2.4 | 2.1 | 2.1 | 1.3 | 1.4 |

TABLE 2

| | Ex. 7 | Ex. 8 | Ex. 9 | Ex. 10 | Ex. 11 | Ex. 12 | Comp. Ex. 3 | Comp. Ex. 4 | Comp. Ex. 5 |
|---|---|---|---|---|---|---|---|---|---|
| Fermentation temperature (° C.) | 1.0 | 1.0 | 5.0 | 5.0 | 1.0 | 1.0 | 1.0 | 5.0 | 8.0 |
| Number of yeast cells added (×10⁶ cells/mL) | 60 | 40 | 60 | 40 | 60 | 60 | 15 | 15 | 60 |
| Real extract (w/w %) | 7.85 | 7.72 | 7.67 | 7.85 | 7.85 | 7.74 | 7.74 | 7.85 | 7.81 |
| Lactic acid (ppm by mass) | 160 | 160 | 160 | 160 | 160 | 160 | 160 | 160 | 160 |
| Phosphoric acid (ppm by mass) | 170 | 170 | 170 | 170 | 170 | 170 | 170 | 170 | 170 |
| Lactic acid + Phosphoric acid (ppm by mass) | 330 | 330 | 330 | 330 | 330 | 330 | 330 | 330 | 330 |
| Ethyl acetate (ppm by mass) | 1.8 | 1.7 | 2.3 | 2.0 | 1.8 | 40.0 | 1.0 | 1.5 | 2.4 |
| Isoamyl acetate (ppm by mass) | 0.2 | 0.2 | 0.2 | 0.1 | 15.0 | 0.2 | 0.1 | 0.2 | 0.2 |
| Ethanol (v/v %) | 0.74 | 0.79 | 0.69 | 0.51 | 0.74 | 0.95 | 0.51 | 0.61 | 0.91 |
| H₂S (ppb by mass) | 2.9 | Not | Not | Not | 2.9 | 2.9 | Not | Not | 11.7 |
| | | detected | detected | detected | | | detected | detected | |
| Diacetyl (ppm by mass) | 0.06 | 0.06 | 0.05 | 0.06 | 0.06 | 0.06 | 0.12 | 0.15 | 0.10 |
| Maltose (% by mass) | 1.9 | 1.9 | 1.9 | 5.1 | 1.9 | 0.7 | 0.7 | 1.9 | 0.7 |
| Feeling of fermentation suitable for beer- | 2.9 | 2.7 | 2.9 | 2.7 | 2.5 | 2.4 | 1.3 | 1.1 | 1.5 |
| flavored beverages | | | | | | | | | |
| Cosmetic fragrance unsuitable for | 2.8 | 2.8 | 2.5 | 2.5 | 2.1 | 2.1 | 2.8 | 2.8 | 2.8 |
| beer-flavored beverages | | | | | | | | | |
| Comprehensive evaluation | A | A | A | A | B | B | C | C | C |

(Detection Limit of H₂S: 1 Ppb by Mass)

The beer-taste beverages of Examples 1 to 6 and Comparative Examples 1 and 2, which are shown in Table 1, were produced under the same conditions, except for the contents of lactic acid and phosphoric acid. From the sensory evaluation performed on these beverages, it was found that the sourness unsuitable for beer-taste beverages can be suppressed, if the contents of lactic acid and phosphoric acid are set to be within certain ranges.

The beer-taste beverages of Examples 7 to 12 and Comparative Examples 3 to 5, which are shown in Table 2, were produced by applying the same contents of lactic acid and phosphoric acid, but by changing fermentation conditions and the contents of ethanol, H₂S and diacetyl. From the sensory evaluation performed on these beverages, it was found that if the contents of ethanol, H₂S and diacetyl are set to be within certain ranges, the produced beverages have a feeling of fermentation suitable for beer-taste beverages, and the cosmetic fragrance unsuitable for beer-taste beverages can be suppressed. In Examples 8 to 10 and Comparative Examples 3 and 4, H₂S was not detected, and the content of H₂S was 1 ppb by mass or less.

1. A beer-taste beverage, comprising less than 0.07 ppm by mass of diacetyl, and 0.4 (v/v)% or more and less than 1.5 (v/v)% of ethanol,
having an H₂S content of less than 5 ppb by mass, and
comprising 50 to 1000 ppm by mass of lactic acid, or 50 to 1000 ppm by mass of phosphoric acid.

2. The beer-taste beverage according to claim 1, comprising 0.01 ppm by mass or more of ethyl acetate.

3. The beer-taste beverage according to claim 1, having a pH value of less than 4.0.

4. The beer-taste beverage according to claim 1, comprising 0.3% to 6.0% by mass of maltose.

5. The beer-taste beverage according to claim 1, having a real extract concentration of 1 to 10 (w/w)%.

6. The beer-taste beverage according to claim 1, wherein the beer-taste beverage is a fermented beer-taste beverage.

7. A method for producing a beer-taste beverage, comprising:
a step of producing a wort from a raw material comprising a malt and water, and
a step of adding a yeast to the wort to perform fermentation, wherein
the additive amount of the yeast in the fermentation step is 40×10⁶ cells/mL or more, and the fermentation temperature is 1° C. to 21° C.

8. The production method according to claim 7, wherein the fermentation time in the fermentation step is 1 hour or more.

9. The production method according to claim 7, further comprising a step of adding hops.

10. The production method according to claim 7, further comprising a step of adding a brewed vinegar.

11. The production method according to claim 7, wherein the yeast is a bottom fermentation yeast.

12. A beer-taste beverage produced by the production method according to claim 7.
